(19) United States
(12) Patent Application Publication
(10) Pub. No.: US 2017/0321131 A1
(43) Pub. Date: Nov. 9, 2017

(54) METHOD FOR RESOLVING CRUDE-WATER EMULSIONS

(71) Applicant: ExxonMobil Research and Engineering Company, Annandale, NJ (US)

(72) Inventors: Ashok Uppal, Sarnia (CA); Babak A. Jajuee, Calgary (CA); Tarek A. Elsolh, Sherwood Park (CA); Jason M. McMullan, Nazareth, PA (US)

(21) Appl. No.: 15/497,505

(22) Filed: Apr. 26, 2017

Related U.S. Application Data
(60) Provisional application No. 62/331,649, filed on May 4, 2016.

(51) Int. Cl. C10G 33/02; C02F 1/48; B01D 17/06

(52) U.S. Cl. CPC C10G 33/02; B01D 17/06; C02F 1/48

(57) ABSTRACT

An electro-kinetic agglomerator for resolving crude oil and water emulsions containing charged particles by the application of a direct current voltage potential. The electro-kinetic agglomerator comprises a shaftless auger with a charged conductive rod positioned in the center of the shaftless auger and a charged porous drum surrounding wherein the electro-kinetic agglomerator has a DC voltage gradient such that the charged particles are attracted to the conductive rod.

### CROSS REFERENCE TO RELATED APPLICATION

This application relates and claims priority to U.S. Provisional Patent Application No. 62/331,649, filed on May 4, 2016, the disclosure of which is incorporated herein specifically by reference in its entirety.

### TECHNICAL FIELD

The present disclosure relates generally to crude oil refining methods. More particularly, the present disclosure relates to systems and methods for resolving crude oil and water emulsions by the application of a direct current voltage potential.

### BACKGROUND

Because of a continuous decline in the availability of conventional crude oil, today's crude oils contain more contaminants, such as fine solids, naphthenic acids and fracturing fluid chemicals, than they once did. These contaminants, which include water, salts and solid particulate matter, may corrode and/or cause solid deposits in refinery equipment and, as such, must be removed from the crude oil before refinery processing.

The impurities are removed from the crude oil using a desalting process, which takes place in a desalter unit, wherein a hot crude oil is mixed with water and a suitable demulsifying agent to form a water-in-oil emulsion which allows for extraction of the salt contaminant into the aqueous layer. The emulsion is then exposed to an electric field which separates it into an oil phase and an aqueous phase. The oil phase forms a top layer in the desalter unit from where it is continuously removed whereas the aqueous phase (or “brine”) accumulates in the bottom of the desalter from where it is continuously removed.

During the separation phase of the desalting process, an emulsion phase of varying composition and thickness forms at the interface of the oil and aqueous layers. Certain crude oil contaminants, including natural surfactants (asphaltenes and resins) and finely divided solid particles (e.g., less than 5 microns), stabilize the emulsion phase and cause the emulsion to persist in the desalter unit. The persistent emulsion problem is prevalent in the processing of high solids content crude oil.

If unresolved, these emulsions may carry-over with the desalted crude oil or carry-under into the aqueous layer. If carried-over, the emulsions may lead to fouling of downstream equipment and disruption of the downstream fractionation process. If carried-under, they disrupt the wastewater treatment process. Consequently, refiners must either control the formation/growth of these emulsions or remove them from desalter units and, using an additional processing step, resolve the emulsion into its constituent parts (i.e., oil, water and solids) to allow for reuse and/or disposal.

Common methods for resolving emulsions include gravitational or centrifugal methods. In the gravity method, the emulsion is allowed to stand in the separator and the density difference between the oil and the water causes the water to settle through and out of the oil by gravity. In the centrifugation method, the stable emulsion is moved from the de-salter unit to a centrifuge which separates the emulsion into separate water, oil and solids. The gravity method requires the use of time-intensive, and thus inefficient, settling tanks as well as costly methods for disposing of the partially resolved emulsion, while the centrifugation method requires large centrifuges that are costly to build and operate.

### SUMMARY

The present disclosure describes electro-kinetic agglomerator systems and methods of using such systems to resolve stable emulsions by the application of a direct current voltage potential to the emulsion which permits the removal of emulsion-stabilizing solids thereby allowing the oil and aqueous phases to separate more efficiently.

Described herein are systems and methods for resolving emulsions, e.g., stable emulsions found in oil refinery de-salting units, by the application of direct current (DC) voltage potential to the emulsion. The application of a DC voltage potential to the emulsion induces the migration of negatively-charged particles present in the emulsion towards the anode by electro-phoresis and induces positively-charged cations and water towards the cathode by electro-osmosis and ion migration.

In certain embodiments of the present invention, an emulsion comprising charged particles is passed through at least one electro-kinetic agglomeration system having a DC voltage gradient such that the charged particles are removed from the system.

Certain other embodiments include the use of an electro-kinetic agglomeration system comprising a positively-charged conductive rod (i.e., anode) positioned inside a porous drum that is negatively-charged (i.e. cathode). In this embodiment, the anodic rod attracts negatively-charged solid particles and repels the positively-charged cations dissolved in the water; while the cathodic porous drum repels the negatively-charged solids particles, attracts the positively-charged cations and associated water, which allows the separate water to pass through the porous drum.

### BRIEF DESCRIPTION OF THE DRAWINGS

Referring to the drawings, which form a part of this disclosure:

FIG. 1 schematically shows arrangements of rotating shaftless augers with fixed anode rods positioned in the center of the shaftless auger;

FIG. 2 schematically shows a screen tube supported on its exterior by a mesh tube according to one embodiment;

FIG. 3 schematically shows a screen tube supported on its exterior and on its interior by a mesh tube according to one embodiment

FIG. 4 schematically shows an experimental device comprising a cuvette containing a crude oil and water mixture and two metal electrodes in contact with said mixture; and

FIGS. 5A-5C show an experimental device containing crude oil and water emulsion and the effect of time and an electric field applied on the resolution of the emulsion. FIG. 5A shows the experimental device before the electric field is applied (at left) and a control experiment (at right). FIG. 5B shows the experimental device after an electric field of 0.25 kV/cm is applied for 4 min (at left) and a control experiment (at right). FIG. 5C shows the experimental device after an electric field is applied for 4 min at 0.25 kV/cm then turned off and held for 90 min without an applied electric field (at left) and a control experiment (at right). The red circles indicate where there is a resolved water layer.

### DETAILED DESCRIPTION

In the following detailed description section, specific embodiments of the present techniques are described. However, to the extent that the following description is specific to a particular embodiment or a particular use of the present techniques, this is intended to be for exemplary purposes only and simply provides a description of the exemplary embodiments. Accordingly, the techniques are not limited to the specific embodiments described below, but rather, include all alternatives, modifications, and equivalents falling within the true spirit and scope of the appended claims.

At the outset, for ease of reference, certain terms used in this application and their meanings as used in this context are set forth. To the extent a term used herein is not defined below, it should be given the broadest definition persons in the pertinent art have given that term as reflected in at least one printed publication or issued patent. Further, the present techniques are not limited by the usage of the terms shown below, as all equivalents, synonyms, new developments, and terms or techniques that serve the same or a similar purpose are considered to be within the scope of the present claims.

“Electro-kinetic” means the motion of particles and/or liquid under the influence of an applied DC electric field. In the present case, both particles and liquid are moving (in different directions) under the influence of an applied DC electric field.

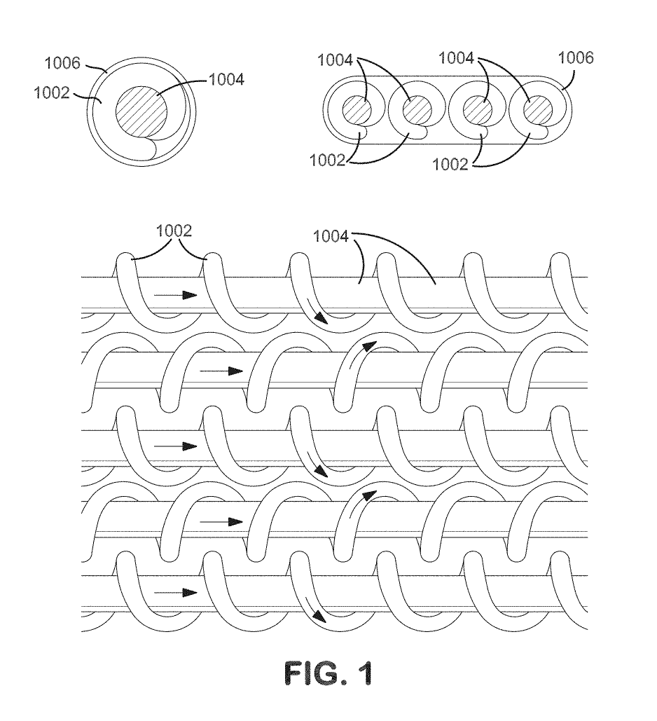

In the present invention, embodiments of which are described herein, the separation of solids from a crude oil and water emulsion is accomplished in an electro-kinetic agglomerator. The emulsion is passed through the electro-kinetic agglomeration system comprising of a conductive rod, which may be positively-charged (anode), placed inside a porous drum which may be negatively-charged (i.e. cathode). The anode attracts negatively-charged solid particles and repels the positively-charged cations dissolved in water. The negatively-charged solid particles may be continuously removed from the system when, for example, the anode rod is positioned lengthwise in the center of rotating shaftless auger, as shown in FIG. 1.

The use of direct current potential to separate the water and solids found in wastewater sludge (“electro-osmotic dewatering”) is described in “Electro-dewatering of wastewater sludge: Influence of operating conditions and their interactions effects” by A. Mahmoud, et al., Water Research, 2011, 45, 2795-2810, incorporated herein by reference.

Electro-osmotic dewatering is generally described in “Application of Electrical Fields in Dewatering and Drying,” by G. Chen, et al., in Dev. Chem. Eng. Mineral Process, 2002, 10, 429-441, incorporated herein by reference. In the method, a material to be dewatered is placed between an anode and a cathode and, when a direct-voltage current is applied, the negatively-charged particles migrate toward the anode and the water is driven towards a porous cathode, which allows the water to be removed from the system.

The application of electro-osmotic dewatering to mine tailings, including the fine residue from a mineral sands operation, is described in “In-situ dewatering of mine tailings using electro-kinetic geosynthetics” by A. B. Fourie, et al., in Tailings and Mine Waste, Proceedings of the Eleventh Tailings and Mine Waste Conference, Oct. 10-13, 2004 while its application to the dewatering of clays is described in “Electroosmotic dewatering of clays. II. Influence of Salt, Acid, and Flocculants,” by N. C. Lockhart, in Colloids and Surfaces, 1983, 6, 239-251. U.S. Patent Application Publication No. 2013/0112561 by Jajuee et al. applies the principles of electro-osmotic (called “electro-kinetic” in the publication) dewatering to the tailings generated during bitumen extraction of mined oil sand. The disclosures of the aforementioned references are hereby incorporated by reference.

Referring to FIG. 1, the anode may be a shaftless auger 1002, or spiral auger, with an opening along the length of the auger and the anode element may be a conductive rod 1004 positioned in the center of the shaftless auger 1002. In the design, any solids that are attracted to the conductive rod 1004 and the rotating spiral auger 1002 will simultaneously scrape the solids off the auger while conveying them out of the system. Surrounding the shaftless auger 1002 and conductive rod 1004 is a screen tube supported by mesh tubes 1006 (or porous drum), which reduce fouling of the cathode compared to systems that lack this element.

The rod is made of a corrosion resistant material. For example, the rod may be made of titanium Grade 1 coated with TELPRO mixed metal coating which consists of IrO₂/Ta₂O₅ and shows little to no corrosion rates in electro-kinetic reactions. As another example, the conductive rod may be made, in whole or in part, of titanium, including a non-titanium core covered with titanium patches or ribbon coated with TELPRO mixed metal coating. Titanium alloys and other non-corrosive conductive materials, such as conductive carbon, gold, silver, or platinum, may also be used.

The auger may be a shaftless auger, as shown in FIG. 1, wherein the auger flights are detached units that rotate over the fixed conductive rod. Alternatively, the auger may be a shafted auger wherein the auger flights are affixed to conductive rod and the auger and conductive rod rotate together.

The size of the shaftless auger, the conductive rod and screen tube as well as the overall design of the electro-kinetic agglomerator may depend on the amount of emulsion to be treated. For example, for small amounts of feed, the system may be comprised of one rotating shaftless auger with one conductive rod in the middle and one cylindrical screen tube. In another example, larger amounts of feed may require the system to be comprised of multiple rotating shaftless augers placed side by side with each of them having a conductive rod in the middle. Additionally, shaftless augers may be made with constant or varying pitches (i.e., spacing between the flights).

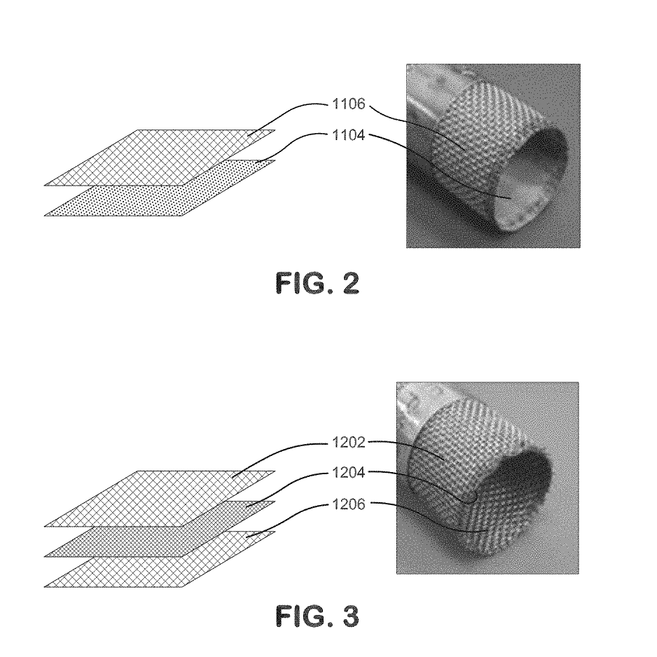

The cathode may be a porous drum that surrounds the auger and conductive rod. The porous drum may comprise a screen, (woven wire) mesh, sintered tube, or other material allowing a continuous hydraulic flow of positively-charged cations and associated water to occur. The porosity and thickness of the drum was found to be the rate-limiting step in the dewatering and solids removal process. A screen tube supported on its outside by a mesh tube significantly improves dewatering performance and reduces fouling tendency in the cathode as compared to a sintered tube. FIG. 2 is a schematic of a screen tube 1104 supported on its outside by a mesh tube 1106.

The screen tube is purposed to allow continuous hydraulic flow of positively-charged cations and associated water to occur by having appropriate pore size and appropriate pore number, based on the operating conditions, such as emulsion composition and flow rate. The screen tube may, for instance, have a nominal pore size of between 10 to 40 μm. The screen tube may, for instance, be made of a metal or metal alloy, such as stainless steel. The selection of the screen tube material is within the ability of a person of ordinary skill in the art based on various considerations. For example, the material of the screen tube (or a coating thereon) may be selected for its corrosion resistance. If the screen tube is supported, for instance by one or two mesh tubes, it should be sufficiently sturdy to withstand the operating conditions. It is desirable to use a screen with minimum thickness and maximum strength. Keeping the screen relatively thin allows for higher dewatering rate and reduces fouling. The screen tube may be woven or non-woven.

As discussed above, the screen tube may be supported on its outside by a mesh tube. A screen exposed to the auger flights fouls eventually due to the pressing action of the flights which forces solids through the screen pores. An inside mesh tube may protect the screen from fouling over an extended period of time. FIG. 3 is a schematic of a screen tube 1204 supported on its outside and on its inside by two mesh tubes 1202 and 1206. The outer mesh tube 1202 provides sturdiness to the system while the inner mesh tube 1206 absorbs the pressure exerted by the auger flights and hence protects the screen from fouling. In this arrangement, the screen is sandwiched between the inside and the outside mesh tubes.

The mesh tubes may have holes which are larger than those of the screen. The mesh tube may, for instance, have a mesh number of 60 to 400, or apertures of 0.01 to 0.001 inches. As with the screen tube, because of the operating environment, the material of the mesh tube (or a coating thereon) may be selected for its corrosion resistance. The thickness of the mesh tube may be, for instance, in the range of 0.05 to 0.5 inches. The mesh tube may be woven or non-woven. It is understood that the selection of the mesh number and thickness of the mesh tube is within the ability of a person of ordinary skill in the art based on various considerations, such as the physical characteristics of the emulsion (e.g., size of emulsion-stabilizing solids).

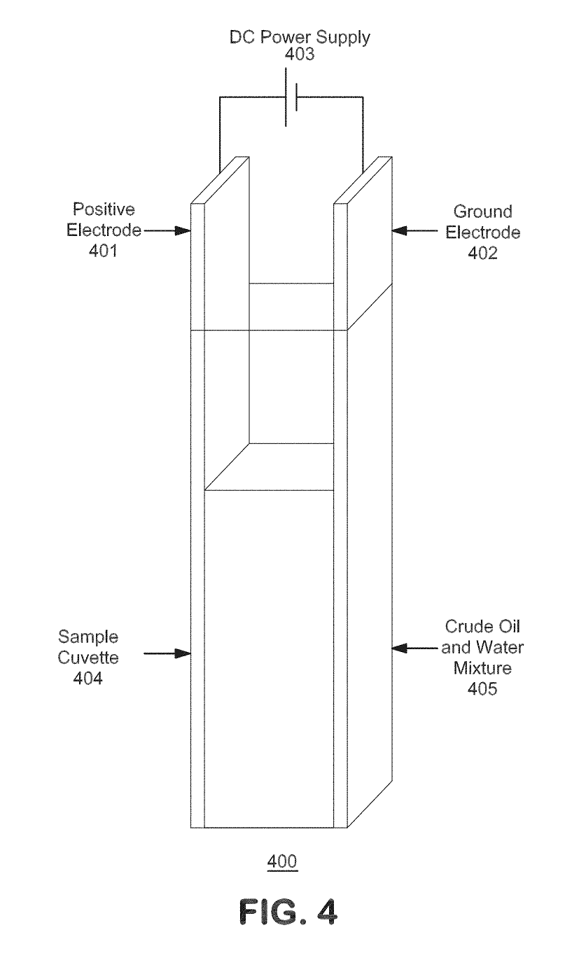

In another embodiment of the present invention, a crude oil and water emulsion may be treated in a sample cuvette at ambient temperature and pressure. The device 400 is shown in FIG. 4 and consists of a cuvette 404, a positive electrode 401 and a ground electrode 402 in contact with a crude oil and water emulsion 405 wherein the electrodes are connected to a DC power supply 403. The conductivity of the crude oil is generally about 40 nS/m at room temperature.

Experiments have shown that electro-kinetic agglomerators effectively and efficiently separate solids from crude oil and water emulsions. Exemplary experiments are detailed herein.

For example, the separation time for a typical crude oil and water emulsion was reduced from 4 hours (gravity method) to approximately 1.5 hours when the emulsion was subjected to a DC voltage gradient of 0.25 kV/cm. The selection of the DC voltage gradient is within the ability of a person of ordinary skill in the art based on design, operational, or other considerations. Higher voltage gradients may be required to resolve certain emulsions. However, the use of a higher voltage gradient must be balanced with a higher emulsion conductivity.

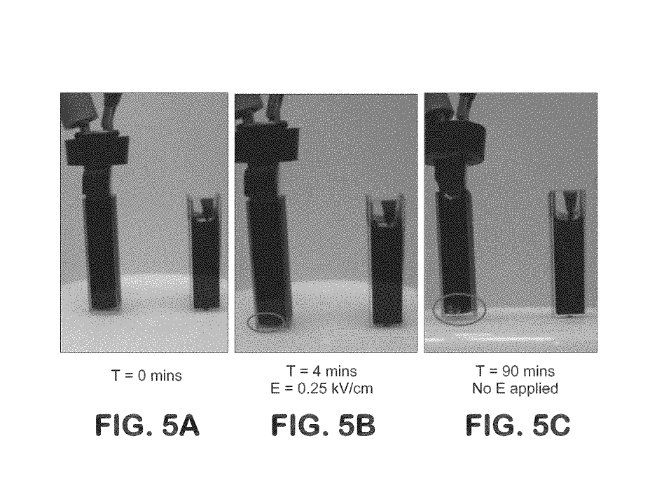

FIGS. 5A-5C compare the emulsion resolution achieved with an electro-kinetic agglomerator of the present invention (pictured at left in each of FIGS. 5A-5C) with a control experiment where no DC current is applied to the emulsion (pictured at right in each of FIGS. 5A-5C). For this comparison, an emulsion comprising 80% crude oil and 20% water was generated in a laboratory blender. The emulsion resolves naturally in 4 hours, i.e., the emulsion breaks into a two-phase oil and water mixture in that time period.

FIG. 5A shows the experimental device before the electric field is applied and a control experiment. There is no resolution of the emulsion before the electric field is applied.

FIG. 5B shows the experimental device after an electric field of 0.25 kV/cm is applied for 4 min and a control experiment. After the application of the electric field, some resolution of the emulsion is achieved as evidenced by the water phase observed at the bottom of the electro-kinetic agglomerator sample (circled in FIG. 5B). There is no resolution of the emulsion in the control experiment.

FIG. 5C shows the experimental device after an electric field is applied for 4 min and then turned off. The experiment is then held for 90 min without an applied electric field, and is compared to a control experiment. After 90 min following the application of the electric field, most of the water is observed at the bottom of the electro-kinetic agglomerator sample (circled in FIG. 5C). There is no resolution of the emulsion in the control experiment.

The use of the electro-kinetic agglomerators of the present invention will reduce the high capital and labor costs associated with the current methods for handling crude oil and water emulsions, e.g., resolution by gravity or centrifugation. Gravity separation requires the time intensive use of settling tanks and, because the technique does not effectively resolve the emulsion, the costly disposal of the partially-resolved solids-containing emulsion. Similarly, the centrifugation method requires the use of large centrifuges that are expensive to build and operate. Conversely, electro-kinetic agglomerators are simpler and cheaper to operate. The resulting water fraction will be low in oil and solids content and, therefore, readily treatable at the wastewater treatment plant. Also, the solids rich oil phase may be routed to the coker. Based on the projected oil recovery and reduced off-site disposal costs afforded by the present invention, a refinery may realize considerable reductions in operating costs.

### Additional Embodiments

### Embodiment 1

An electro-kinetic agglomerator for resolving crude oil and water emulsions, the emulsion containing charged particles, the electro-kinetic agglomerator comprising: a shaftless auger with an opening along the length of the auger; a conductive rod positioned in the center of the shaftless auger, having a charge to attract the charged particles; a porous drum at least partially surrounding the auger, having a charge to repel the charged particles; and wherein the electro-kinetic agglomerator has a DC voltage gradient such that the charged particles are attracted to the conductive rod.

### Embodiment 2

The electro-kinetic agglomerator of embodiment 1, wherein the conductive rod is positively charged.

### Embodiment 3

The electro-kinetic agglomerator of any of the previous embodiments, wherein the conductive rod is at least partially covered by a corrosion-resistant coating.

### Embodiment 4

The electro-kinetic agglomerator of any of the previous embodiments, wherein the conductive rod comprises titanium and the corrosion-resistant coating is a mixed metal coating consisting of IrO₂ and Ta₂O₅.

### Embodiment 5

The electro-kinetic agglomerator of any of the previous embodiments, wherein the conductive rod comprises at least one of titanium, a titanium alloy, conductive carbon, gold, silver or platinum.

### Embodiment 6

The electro-kinetic agglomerator of any of the previous embodiments, wherein the shaftless auger comprises flights having constant or varying pitches.

### Embodiment 7

The electro-kinetic agglomerator of any of the previous embodiments, wherein the porous drum comprises a screen tube supported by at least one mesh tube.

### Embodiment 8

The electro-kinetic agglomerator of any of the previous embodiments, wherein the screen tube has a nominal pore size of between 10 to 40 μm.

### Embodiment 9

The electro-kinetic agglomerator of any of the previous embodiments, wherein the at least one mesh tube has a mesh number of between 60 to 400.

### Embodiment 10

A method of resolving a crude oil and water emulsion, the emulsion containing charged particles, the method comprising: providing a crude oil and water emulsion comprising charged particles; and contacting the emulsion with an electro-kinetic agglomerator having a DC voltage gradient to remove the charged particles from the emulsion.

### Embodiment 11

The method of embodiment 10, wherein the electro-kinetic agglomerator comprises: a shaftless auger with an opening along the length of the auger; a conductive rod positioned in the center of the shaftless auger, having a charge to attract the charged particles; a porous drum at least partially surrounding the auger, having a charge to repel the charged particles; and wherein the electro-kinetic agglomerator has a DC voltage gradient such that the charged particles are attracted to the conductive rod.

### Embodiment 12

An electro-kinetic agglomerator for resolving crude oil and water emulsions, the emulsion containing charged particles, the electro-kinetic agglomerator comprising: a positive electrode; a ground electrode; a crude oil and water emulsion positioned between the positive and ground electrodes; wherein the electro-kinetic agglomerator has a DC voltage gradient such that the charged particles are attracted to the positive electrode and the emulsion is in direct contact with the positive and ground electrodes.

The embodiments and examples described herein are merely illustrative, as numerous other embodiments may be implemented without departing from the spirit and scope of the exemplary embodiments of the present application. Moreover, while certain features of the application may be shown on only certain embodiments or configurations, these features may be exchanged, added, and removed from and between the various embodiments or configurations while remaining within the scope of the application. Likewise, methods described and disclosed may also be performed in various sequences, with some or all of the disclosed steps being performed in a different order than described while still remaining within the spirit and scope of the present application. Additionally, the illustrations are merely representational and may not be drawn to scale.

The above disclosed subject matter shall be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure may be determined by the broadest permissible interpretation of the following claims and their equivalents, and shall not be restricted or limited by the foregoing detailed description.

1. An electro-kinetic agglomerator for resolving crude oil and water emulsions, the emulsion containing charged particles, the electro-kinetic agglomerator comprising:
a shaftless auger with an opening along the length of the auger;
a conductive rod positioned in the center of the shaftless auger, having a charge to attract the charged particles;
a porous drum at least partially surrounding the auger, having a charge to repel the charged particles; and
wherein the electro-kinetic agglomerator has a DC voltage gradient such that the charged particles are attracted to the conductive rod.

2. The electro-kinetic agglomerator of claim 1, wherein the conductive rod is positively charged.

3. The electro-kinetic agglomerator of claim 2, wherein the conductive rod is at least partially covered by a corrosion-resistant coating.

4. The electro-kinetic agglomerator of claim 3, wherein the conductive rod comprises titanium and the corrosion-resistant coating is a mixed metal coating consisting of IrO₂ and Ta₂O₅.

5. The electro-kinetic agglomerator of claim 2, wherein the conductive rod comprises at least one of titanium, a titanium alloy, conductive carbon, gold, silver or platinum.

6. The electro-kinetic agglomerator of claim 2, wherein the shaftless auger comprises flights having constant or varying pitches.

7. The electro-kinetic agglomerator of claim 2, wherein the porous drum comprises a screen tube supported by at least one mesh tube.

8. The electro-kinetic agglomerator of claim 7, wherein the screen tube has a nominal pore size of between 10 to 40 μm.

9. The electro-kinetic agglomerator of claim 7, wherein the at least one mesh tube has a mesh number of between 60 to 400.

10. A method of resolving a crude oil and water emulsion, the emulsion containing charged particles, the method comprising:
providing a crude oil and water emulsion comprising charged particles; and
contacting the emulsion with an electro-kinetic agglomerator having a DC voltage gradient to remove the charged particles from the emulsion.

11. The method of claim 10, wherein the electro-kinetic agglomerator comprises:
a shaftless auger with an opening along the length of the auger;
a conductive rod positioned in the center of the shaftless auger, having a charge to attract the charged particles;
a porous drum at least partially surrounding the auger, having a charge to repel the charged particles; and
wherein the electro-kinetic agglomerator has a DC voltage gradient such that the charged particles are attracted to the conductive rod.

12. An electro-kinetic agglomerator for resolving crude oil and water emulsions, the emulsion containing charged particles, the electro-kinetic agglomerator comprising:
a positive electrode;
a ground electrode;
a crude oil and water emulsion positioned between the positive and ground electrodes;
wherein the electro-kinetic agglomerator has a DC voltage gradient such that the charged particles are attracted to the positive electrode and the emulsion is in direct contact with the positive and ground electrodes.
